(19) United States
(12) Patent Application Publication
(10) Pub. No.: US 2011/0038366 A1
(43) Pub. Date: Feb. 17, 2011

(54) SWITCHING DATA STREAMS BETWEEN CORE NETWORKS

(75) Inventor: Michael Brett Wallis, McKinney, TX (US)

Correspondence Address: FISH & RICHARDSON P.C. (DA), P.O. BOX 1022, MINNEAPOLIS, MN, 55440-1022, US

(73) Assignee: Mavenir Systems, Inc., Richardson, TX (US)

(21) Appl. No.: 12/846,718

(22) Filed: Jul. 29, 2010

Related U.S. Application Data
(60) Provisional application No. 61/229,603, filed on Jul. 29, 2009.

(51) Int. Cl. H04L 12/66

(52) U.S. Cl. 370/352

(57) ABSTRACT

The present disclosure is directed to switching data streams between core networks. In some implementations, a method can include identifying a plurality of different RTP streams from a SIP device with at least one stream associated with a supplementary service. A plurality of single media streams for a plurality of different mobile devices in a cellular core network is identified. Dynamically switching connections between each RTP stream in the plurality of different RTP streams and a corresponding single media stream in the plurality of single media streams based, at least in part, on SIP signaling from the SIP device.

### CLAIM OF PRIORITY

This application claims priority under 35 USC §119(e) to U.S. Provisional Application No. 61/229,603, filed Jul. 29, 2009, the entire disclosure of which is incorporated herein by reference.

### TECHNICAL FIELD

This invention relates to telecommunications and, more particularly, to switching data streams between core networks.

### BACKGROUND

Communication networks include wired and wireless networks. Example wired networks include the Public Switched Telephone Network (PSTN) and the Internet. Example wireless networks include cellular networks as well as unlicensed wireless networks that connect to wired networks. Calls and other communications may be connected across wired and wireless networks.

Cellular networks are radio networks made up of a number of radio cells, or cells that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Global System for Mobile Communication (GSM) protocols, Code Division Multiple Access (CDMA) protocols, Universal Mobile Telecommunications System (UMTS), and others. Cellular networks communicate in a radio frequency band licensed and controlled by the government.

Unlicensed wireless networks are typically used to wirelessly connect portable computers, PDAs and other computing devices to the internet or other wired network. These wireless networks include one or more access points that may communicate with computing devices using an 802.11 and other similar technologies.

### SUMMARY

The present disclosure is directed to switching data streams between core networks. In some implementations, a method can include identifying a plurality of different RTP streams from a SIP device with at least one stream associated with a communication session. A plurality of single media streams for a plurality of different mobile devices in a cellular core network is identified. Dynamically switching connections between each RTP stream in the plurality of different RTP streams and a corresponding single media stream in the plurality of single media streams based, at least in part, on SIP signaling from the SIP device.

In some implementations, the system and/or method may include one or more of the following: H.248 control of RTP resources at the Media Gateway (MG), Access Session Border Controller (SBC), Border Gateway (BG); support for text-encoded H.248.1 version 1, 2, and/or 3; support for the H.248 Add, Modify, Subtract, Move and ServiceChange commands; support for moving a network-facing RTP termination from one context to another, matching it up with the appropriate/active RTP stream from the peer network; support for modifying the remote RTP address (i.e. the Remote Descriptor) to identify the appropriate/active RTP stream from the SIP divide; support for maintaining proper RTP timestamp and sequence numbers as RTP endpoints are moved between H.248 contexts; SBC support for multiple H.248 controllers (e.g., there will be anywhere from 2 to 8 communication node nodes in the network which will be issuing H.248 commands for resiliency and load balancing), but initially it can be a one to one association with a roadmap to support multiple communication nodes; no transcoding is required (PCMU is used end-to-end); and/others.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example communication system in accordance with some implementations of the present disclosure;

FIG. 2 illustrates an example communication node and mobile switching center of FIG. 1;

FIG. 3 illustrates an example bearer gateway of FIG. 2;

FIGS. 4-6 illustrate example call flows for managing media data streams; and

FIG. 7 is a flow chart illustrating an example method for switch between RTP streams from a single SIP device.

Like reference symbols in the various drawings indicate like elements.

### DETAILED DESCRIPTION

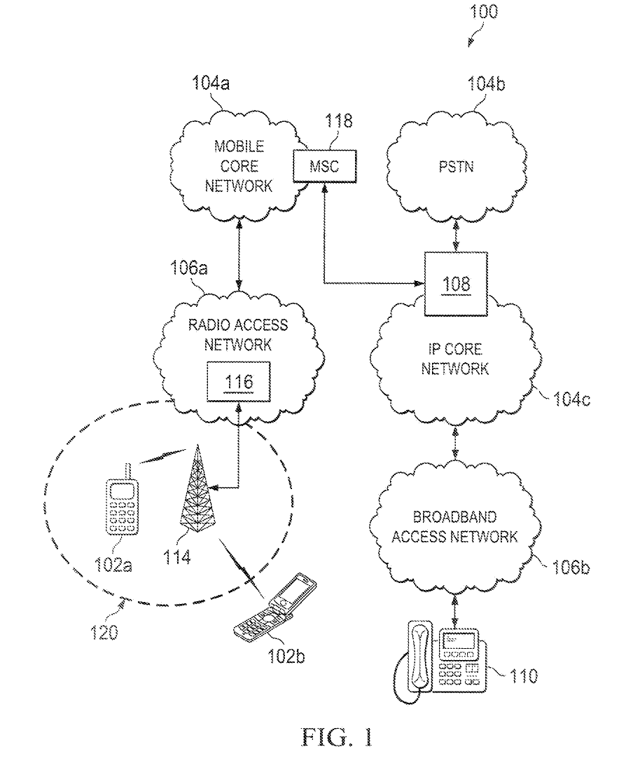

FIG. 1 is an example communication system 100 for selectively switching between different data media streams from a single device. For example, the system may selectively switch different media streams from a Session Initiation Protocol (SIP) device with a single media stream from a cellular device. In Internet Protocol (IP) systems, media data streams may include Real-time Transport Protocol (RTP) streams from, for example, a SIP device. In cellular systems, media streams may include Time-Division Multiplexing (TDM) streams, RTP streams, Asynchronous Transfer Mode (ATM) streams, and/or other streams. In general, cellular devices typically support a single media stream that may be shared between multiple calls. IP devices, such as SIP devices, generate a new media session for each call. Scenarios may include calling one remote party, putting that call on hold, and then calling a second remote party. In some implementations, the system 100 may dynamically switch multiple media sessions in an IP network with a single session in a cellular network. For example, the system 100 may identify a plurality of RTP streams from a single SIP device and selectively switch the different streams to a single media stream from a mobile device in a mobile core network. In connection with switching between different data streams, the system 100 may translate the data stream from a first protocol to a second protocol. For example, the system 100 may translate, prior to transmission to a mobile core network, an RTP stream to a TDM stream, an ATM stream, and/or other stream. In some implementations, the system 100 may execute one or more of the following: generate a plurality of different data streams from a single device; receive the plurality of different data streams and associated signaling for each stream; selectively switch between the different data streams based, at least in part, on the associated signaling; transmit the selected data stream to a mobile core network across a single interface; and/or others. By switching between the different data streams from the single device, the system 100 may bridge the single steady-state connection for media streams in a mobile core network and the multiple steady-state connections for media streams from a single SIP device.

At a high level, the system 100, in some implementations, includes cellular devices 102a and 102b, core networks 104a-d, access networks 106a and 106b, a communication node 108, and a SIP device 110. As for a high level description, the SIP device 110 may establish multiple media sessions through the communication node 108 to the mobile devices 102a and 102b. For example, the SIP device 110 may establish a media session with the mobile device 102a and a media session with the mobile device 102b. In connection with receiving the media sessions, the communication node 108 may receive signaling and media associated with each media session. Based, at least in part, on the signaling, the communication node 108 may dynamically switch between the different media sessions with the SIP device 110 and pass the selected media session to a Mobile Switching Center (MSC) 118 in the mobile core network 104a. By switching between the different media sessions, the system 100 may reuse the single steady-state connection between the MSC 118 and the communication node 108 when providing supplementary services to the SIP device 110.

Turning to a more detailed description of the elements, each mobile device 102 comprises an electronic device operable to receive and transmit wireless communication with system 100. As used in this disclosure, mobile devices 102 are intended to encompass cellular phones, data phones, pagers, portable computers, SIP phones, smart phones, personal data assistants (PDAs), one or more processors within these or other devices, or any other suitable processing devices capable of communicating information using cellular radio technology. In the illustrated implementation, mobile devices 102 are able to transmit in one or more cellular band. In these cases, messages transmitted and/or received by mobile devices 102 may be based on a cellular radio technology. There may be any number of mobile devices 102 communicably coupled to cellular access network 106a and/or femtocell device 110. Generally, the mobile devices 102 may transmit voice, video, multimedia, text, web content or any other user/client-specific content. In short, device 102 generates requests, responses or otherwise communicates with mobile core network 104a through RAN 106a. While the mobile devices 102a and 102b are illustrated as communicating with the same RAN 106a, the devices 102 may communicate through different RANs without departing from the scope of this disclosure.

The SIP device 110 comprises an electronic device operable to receive and transmit network communication using SIP. The illustrated SIP device 110 is a SIP phone but may be a cellular phones, data phones, pagers, portable and stationary computers, smart phones, personal data assistants (PDAs), televisions, electronic gaming devices, one or more processors within these or other devices, or any other suitable processing devices capable of communicating information over a wireless or wired link to access networks 106. In some implementations, the SIP devices 110 may transmit voice or other data to the communication node 108 using an RTP media stream and associated signaling using a SIP stream. The SIP device 110 may generate a different media stream for each supplementary services executed. In other words, the SIP device 110 may allocate new media sessions for each call, i.e., for each SIP dialog. As previously mentioned, the SIP devices 110 manage multiple media streams for supplementary services while the MSC 118 uses a single media stream for multiple supplementary service invocations. For example, the SIP device 110 may generate a first RTP stream with the communication node 108 for a communication session with the mobile device 102a and generate a second RTP stream with the communication node 108 in connection with placing the initial call on hold and answering a different call from the mobile device 102b.

In the illustrated implementation, core networks 104 include cellular core network 104a, Public Switched Telephone Network (PSTN) 104b, and IP network 104c. The cellular core network 104a typically includes various switching elements, gateways and service control functions for providing cellular services. The cellular core network 104a often provides these services via a number of cellular access networks (e.g., RAN) and also interfaces the cellular system with other communication systems such as PSTN 104b via mobile switching center (MSC) 118. In accordance with the cellular standards, the cellular core network 104a may include a circuit switched (or voice switching) portion for processing voice calls and a packet switched (or data switching) portion for supporting data transfers such as, for example, e-mail messages and web browsing. The circuit switched portion includes MSC 118 that switches or connects telephone calls between cellular access network 106a and PSTN 104b or another network, between cellular core networks or others. The MSC 118 may support only a single media stream (e.g., single TDM channel for the standard A-interface, single RTP stream for AoIP) towards the RAN 106. This single media stream may be used for supplementary services which involve multiple calls to/from the mobile such as call waiting. In other words, multiple calls to/from a GSM mobile share a single media connection on the MSC's access interface.

The cellular core network 104a may also include a home location register (HLR) for maintaining “permanent” subscriber data and a visitor location register (VLR) (and/or an SGSN) for “temporarily” maintaining subscriber data retrieved from the HLR and up-to-date information on the location of those communications devices 102 using a wireless communications method. In addition, the cellular core network 104a may include Authentication, Authorization, and Accounting (AAA) that performs the role of authenticating, authorizing, and accounting for devices 102 operable to access GSM core network 104a. While the description of the core network 104a is described with respect to GSM networks, the core network 104a may include other cellular radio technologies such as UMTS, CDMA, and others without departing from the scope of this disclosure.

PSTN 104b comprises a circuit-switched network that provides fixed telephone services. A circuit-switched network provides a dedicated, fixed amount of capacity (a “circuit”) between the two devices for the duration of a transmission session. In general, PSTN 104b may transmit voice, other audio, video, and data signals. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the form of either dial pulses or multi-frequency tones.

As mentioned above, the access networks 106 include RAN 106a and broadband network 106b. RAN 106a provides a radio interface between mobile device 102a and the cellular core network 104a which may provide real-time voice, data, and multimedia services (e.g., a call) to mobile device 102a. In general, RAN 106a communicates air frames via radio frequency (RF) links. In particular, RAN 106a converts between air frames to physical link based messages for transmission through the cellular core network 104a. RAN 106a may implement, for example, one of the following wireless interface standards during transmission: Advanced Mobile Phone Service (AMPS), GSM standards, Code Division Multiple Access (CDMA), Time Division Multiple Access (TDMA), IS-54 (TDMA), General Packet Radio Service (GPRS), Enhanced Data Rates for Global Evolution (EDGE), or proprietary radio interfaces. Users may subscribe to RAN 106a, for example, to receive cellular telephone service, Global Positioning System (GPS) service, XM radio service, etc.

RAN 106a may include Base Stations (BS) 114 connected to Base Station Controllers (BSC) 116. BS 114 receives and transmits air frames within a geographic region of RAN 106a (i.e., transmitted by a cellular device 102e) and communicates with other mobile devices 102 connected to the GSM core network 104a. Each BSC 116 is associated with one or more BS 114 and controls the associated BS 114. For example, BSC 116 may provide functions such as handover, cell configuration data, control of RF power levels or any other suitable functions for managing radio resource and routing signals to and from BS 114. MSC 118 handles access to BSC 116 and communication node 108, which may appear as a BSC 116 to MSC 118. MSC 118 may be connected to BSC 116 through a standard interface such as the A-interface. While the elements of RAN 106a are describe with respect to GSM networks, the RAN 106a may include other cellular technologies such as UMTS, CDMA, and/or others. In the case of UMTS, the RAN 106a may include Node B and Radio Network Controllers (RNC).

The IP core network 104c and the broadband access network 106b facilitate wireline communication between the SIP device 110 and any other devices. As described, the IP core network 104c and the broadband access network 106b may communicate IP packets to transfer voice, video, data, and other suitable information between network addresses. While the broadband access network 106 is illustrated as a wired network (e.g., DSL, cable modem access), the access network 106b may be 3G/4G wireless broadband networks (e.g., UMTS, HSDPA, WiMax, WiFi, LTE, etc.) without departing from the scope of this disclosure. In the illustrated implementations, the access network 106b includes or is otherwise coupled to the SIP device 110. The SIP device 110 can include any software, hardware, and/or firmware operable to communicate with the communication node 108 using SIP. For example, the SIP device 110 may transmit SIP and RTP messages to the communication node 108 to transmit signaling and data, respectively. In some implementations, the messages may be routed through the IP core network 104c and the broadband access network 106b using standard IP processing.

In some implementations, the IP core network 104c includes an IP Multimedia Subsystem (IMS) network and associated elements. In general, an IMS network is a network that enables mobile communication technology to access IP multimedia services. The IMS standard was introduced by the 3rd Generation Partnership Project (3GPP) which is the European 3rd generation mobile communication standard. The IMS standards disclose a method of receiving an IP based service through a wireless communication terminal such as those communication devices 102 which are capable of wireless communications and include an IMS client, for example wireless telephone 102b. To achieve these goals, IMS network uses SIP and, in some implementations, wireless telephone 102b is operable to use the same protocol when accessing services through broadband access network 106b. Although not illustrated, IMS network may include Call Session Control Function (CSCF), Home Subscriber Server (HSS), Application Server (AS), and other elements. CSCF acts as a proxy and routes SIP messages to IMS network components such as Application Server AS. HSS typically functions as a data repository for subscriber profile information, such as a listing of the type of services allowed for a subscriber. AS provides various services for users of IMS network, such as, for example, video conferencing, in which case AS handles the audio and video synchronization and distribution to communication devices 102.

The communication node 108 can include any software, hardware, and/or firmware operable to selectively switching between different media sessions from the SIP device 110. For example, the SIP device 110 may generate a media session for an initial call and a media session for each supplementary service executed. As previously mentioned, the supplementary services may include one or more of the following: call waiting; three-way calling; hold plus second call; retrieve; and/or others. For example, the communication node 108 may initially map a first RTP session from SIP device 110 towards the MSC 118 and then dynamically switches to a second SIP session from the SIP device 110. In some implementations, the communication node 108 may execute one or more of the following: receive a plurality of media sessions from the SIP device 110; receive signaling associated with the plurality of media sessions in SIP streams from the SIP device 110; determine status information of the call sessions based, at least in part, on the received signaling; dynamically switching between the different data streams as the signaling is updated; transmit the selected data stream to the MSC; and/or others. As previously mentioned, the SIP device 110 may establish a plurality of different media sessions for each executed service. For example, the SIP device 110 may establish a media session with the communication node 108 for an initial call and a media session with the communication node 108 for subsequently executed supplementary services. In connection with communicating with the mobile devices 102a and 102b, the communication node 108 may identify the plurality of different data streams from the SIP device 110. In addition, the communication node 108 may determine status information for each stream based, at least in part, on the SIP signals. For example, the communication node 108 may receive information indicating that an initial call session with the mobile device 102a is on hold and a second call session is established between the mobile device 102b and the SIP device 110. In managing different media streams, communication node 108 may convert between different protocols. For example, the communication node 108 may receive a TDM stream from the mobile device 102 and convert the TDM stream to an RTP stream prior to transmission to the SIP device 110. In this case, the communication node 108 may convert between RTP streams and streams compatible with the cellular network 104 such as TDM streams or ATM streams. In some implementations, the communication node 108 may bridge the multiple RTP streams with a single media stream by, for example, a subtending media gateway (MGW), controlled via H.248. As the SIP device 110 generates additional dialogs, additional H.248 contexts may be created and the MSC-facing termination may be moved to the appropriate context, i.e., to the context which contains the active RTP session towards the SIP device. To continue the ability to hide the different media requirements from the respective RTP endpoints, such as the SIP device 110 and the MSC 118, the communication node 108 may control user plane endpoints so that the single RTP stream from the MSC 118 may be associated with the appropriate RTP stream from the SIP device 110.

Communication node 108 may, in one embodiment, emulate or otherwise represent itself as an element of core network 104. For example, communication node 108 may emulate or otherwise represent itself as a BSC, MSC, AS (Application Server) or other element of a core network 104. In the case that communication node 108 emulates a BSC, communication node 108 may be queried by MSC 118 in cellular core network 104a like any other BSC 116. In the case that communication node 108 emulates an AS, communication node 108 may be queried by the IMS network like any other AS.

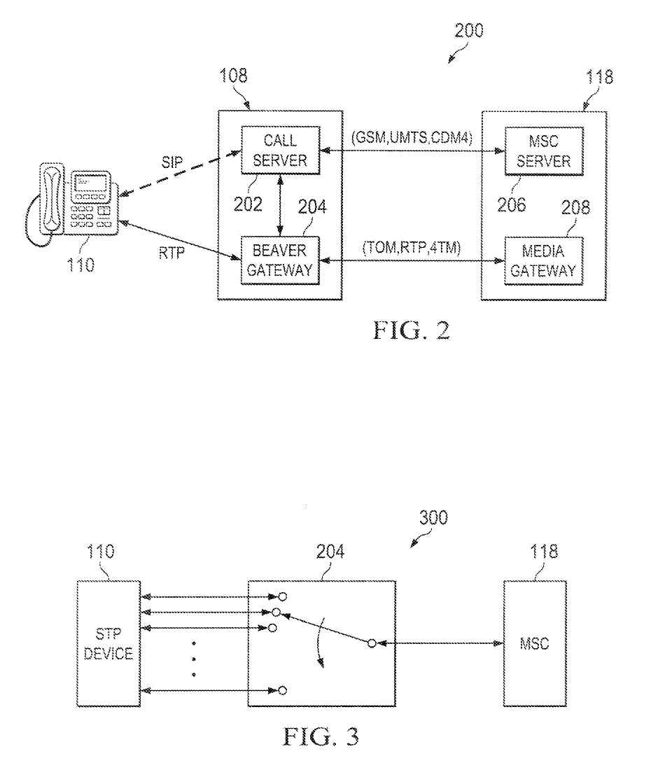

FIG. 2 is a block diagram illustrating a communication system 200 including an example communication node 108 and an example MSC 118 in accordance with some implementations of the present disclosure. In the illustrated implementation, the communication node 108 includes a call server 202 and a bearer gateway 204. The call server 202 receives SIP signaling from the SIP device 110 and transmits switching commands to the bearer gateway 204 based, at least in part, on the received signaling. For example, the call server 202 may dynamically switch the bearer gateway 204 between different RTP streams in accordance with the receive SIP signaling. For example, the call server 202 may transmit H.248 commands to the bearer gateway 204. The bearer gateway 204 switches the multiple RTP streams with the single media data stream from the MSC 118. For example, the bearer gateway 204 may disconnect one RTP stream from the single media stream and connect a second RTP stream to the single media stream to form a communication session. In some implementations, the bearer gateway 204 may translate between an RTP media stream and a stream compatible with the MSC 118 such as TDM or ATM. In the illustrated example, the MSC server 206 exchanges signaling information with the call server 202. The media gateway 208 exchanges media data sessions with the bearer gateway 204. In some implementations, the bearer gateway 204 may be a Session Border Controller (SBC) or Border Gateway (BG) used in a manner similar to an MGW with RTP interfaces instead of TDM.

FIG. 3 illustrates a communication system 204 including an example bearer gateway 204. In this example, the system 204 includes the SIP device 110 communicating media streams with the MSC 118 through the bearer gateway 204. The bearer gateway 204 is an Nx1 switch that dynamically switches a plurality of different RTP streams from the SIP device 110 with a single interface from the MSC 118.

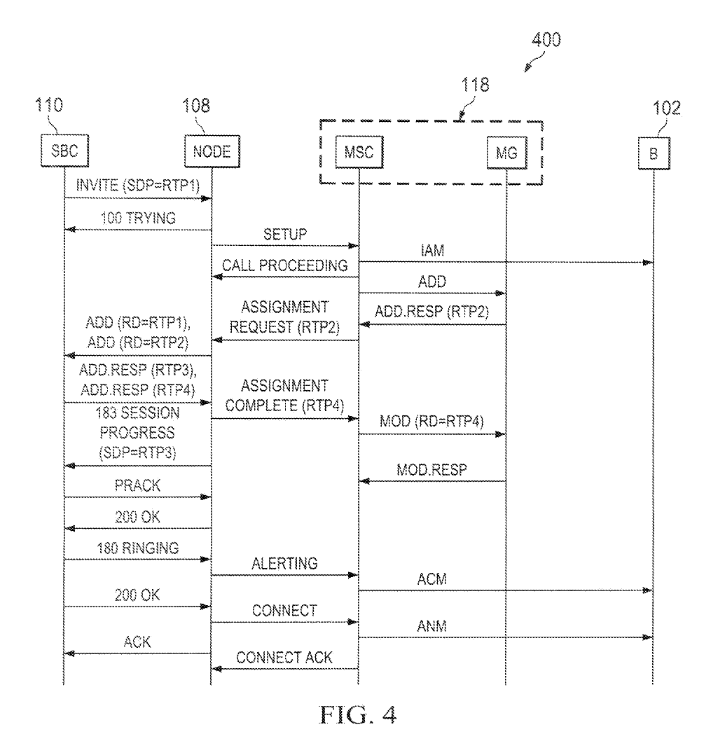

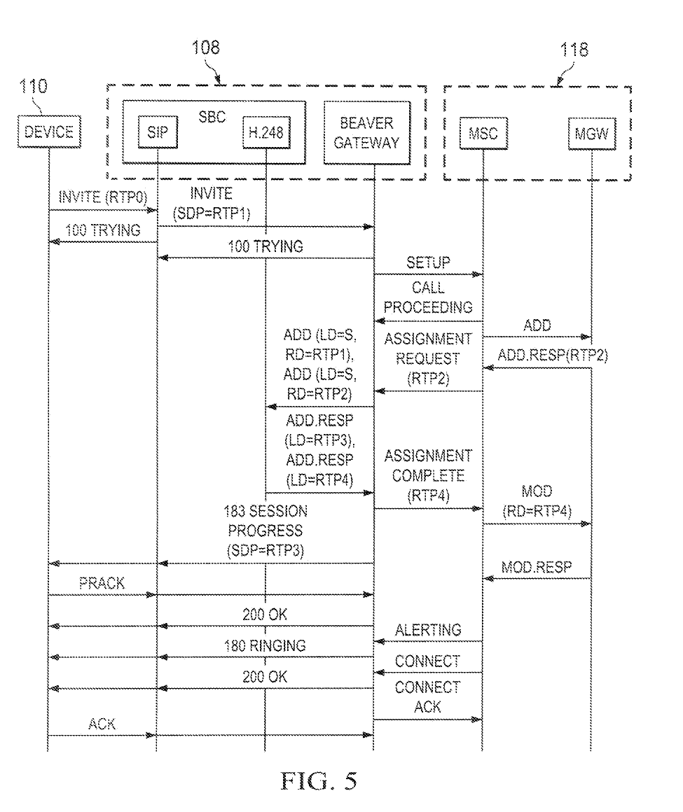

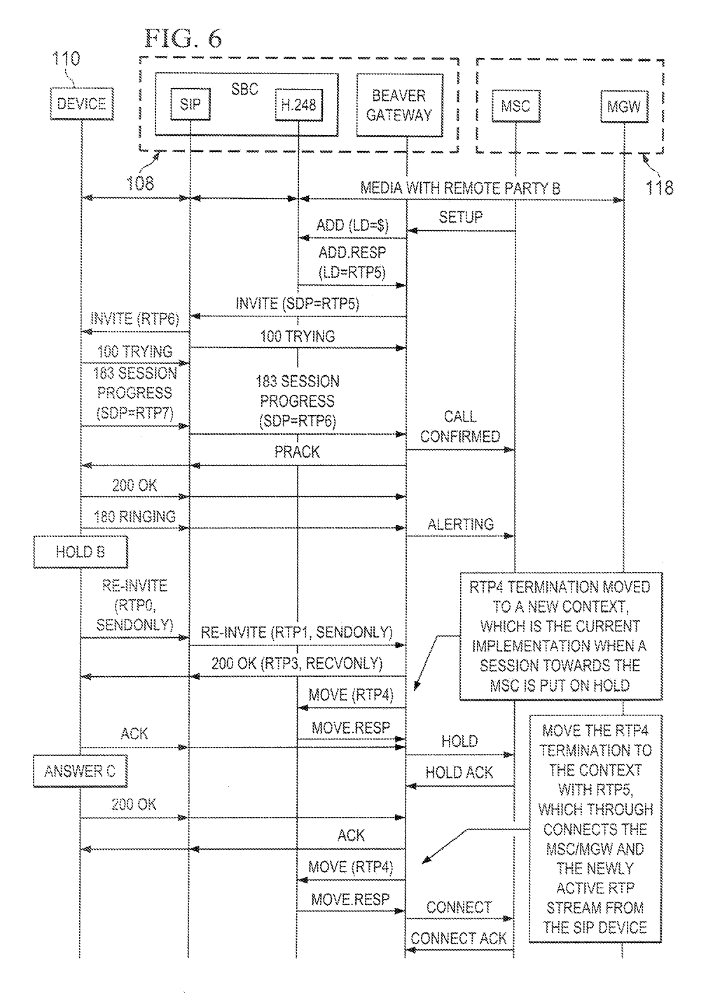

FIGS. 4-6 illustrate example call flows 400, 500, and 600, respectively. The call flow 400 illustrates a process for switching a single media session with a plurality of different media sessions through an IP network 104c. In particular, a media session is established between the SIP device 110 and the device 102. In response to at least a request to access supplementary services, The SIP device establishes an additional RTP stream with the communication node 108. The communication node 108 switches the connection with the single interface from the MSC 118 between a plurality of different RTP streams from the SIP device 110. Referring to FIG. 5, the call flow 500 may enable the connectivity of the RTP endpoints. As shown in the flow, RTP3 and RTP4 are the SBC's H.248 controlled RTP endpoints, grouped together in Context 1. RTP4 is the remote RTIP address that the MSC/MGW will see for the life of the call, regardless of what services are invoked and how many SIP dialogs and RTP streams the SIP device creates. The communication node controls the RTP4 termination and the device-side RTP stream. Referring to FIG. 6, the call flow 600 may add to the flow 500. In this case, the remote party C calls the SIP device, which is involved in the call with party B established in the previous flow 500. The SIP device puts party B on hold and answers the call from party C. This establishes a 2nd SIP dialog and media stream from the SIP device. The MSC/MGW is now connected to the newly active RTP stream from the MSC, with the other RTP stream on hold. The remote RTP endpoint that the MSC/MGW is connected with (RTP4) has not changed, satisfying the MSC's media connection requirements.

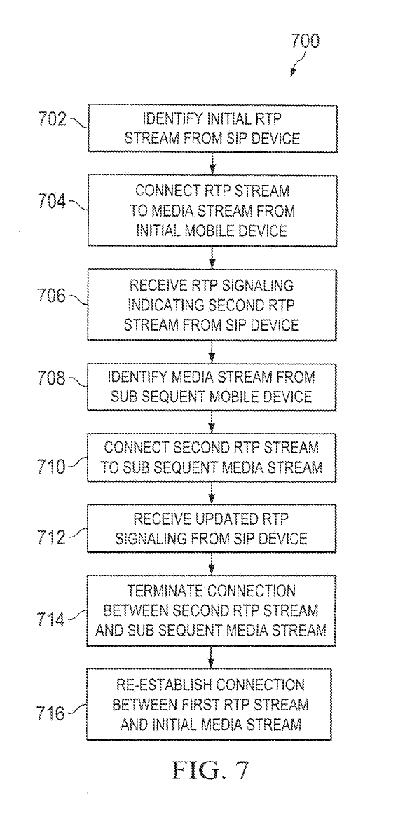

FIG. 7 is a flow chart illustrating an example method 700 for dynamically switching between different RTP streams connected to a cellular core network. The illustrated method is described with respect to system 100 of FIG. 1, but this method could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Method 700 begins at step 702 where an initial RTP stream from an SIP device is identified. For example, the SIP device 110 of FIG. 1 may transmit an initial RTP stream to the communication node 108. In connection with the RTP stream, the SIP device 110 may transmit RTP signaling to the node 108 as well. At step 704, the initial RTP stream is connected to a media stream of an initial mobile device. In the example, the communication node 108 may connection the RTP stream from the SIP device 110 with a media stream from the mobile device 102a and, in some instances, may translate between SIP and a circuit-switched protocol (e.g., TDM, ATM). Next, at step 706, RTP signaling identifying a second RTP stream from the single SIP device is received. Again in the example, the communication node 108 may receive RTP signaling from the SIP device 110 indicating a second RTP stream for a different communication session. For instance, the communication node 108 may receive an indication to place the initial communication session on hold and connect the second RTP stream from the single SP device with a second mobile device 102b. In response to at least the RTP signaling, the communication node 708 may identify a media stream from a subsequent mobile device at step 708. For example, the communication node 708 may receive a request to initiate a call with the SIP device 110 from mobile device 102b or receive a request to initiate a call with the device 102b. In the latter case, the communication node 708 may transmit a request to initiate a call session to the mobile device 102b and identify the associated media stream from the mobile device 102b. At step 710, the second RTP stream and the subsequent media stream are connected. Again returning to the example, the communication node 708 may switch the second RTP stream to the subsequent media stream to establish a communication session. Next, at step 712, updated RTP signaling from the single SIP device may be received. As for the example, the communication node 108 may receive updated RTP signaling indicating that the communication session with the mobile device 102b has been placed on hold. In response to at least the updated RTP signaling, the connection between the second RTP stream and the subsequent media stream may be terminated at step 714. At step 716, the communication session between the first RTP stream and the initial media stream is re-established. In the example, the communication node 108 may re-connected the communication session between the SIP device 110 and the mobile device 102a.

A number of embodiments of the invention have been described. Nevertheless, it will be understood that various modifications may be made without departing from the spirit and scope of the invention.

1. A method, comprising:
identifying, at a network node, a plurality of different Real-time Transport Protocol (RTP) streams from a Session Initiation Protocol (SIP) device with at least one stream associated with a supplementary service, the network node includes at least one interface to an Internet Protocol (IP) network and at least one interface to a cellular core network, the SIP device in the IP network;
identifying a first media stream from a first mobile device in the cellular core network; and
dynamically switching connections between the plurality of different RTP streams between corresponding single media streams for mobile devices in the cellular network based, at least in part, on SIP signaling from the SIP device, the single media streams include at least the first media stream of the first mobile device.

2. The method of claim 1, further comprising controlling the dynamic switching using an access session border controller.

3. The method of claim 1, further comprising translating between SIP communication and circuit switched communication.

4. The method of claim 1, the network node receives the plurality of RTP streams through different interfaces to an IP network and receives the single media stream from the mobile device through a single interface to the cellular core network.

5. The method of claim 1, wherein dynamically switching the single media stream between the plurality of different RTP streams comprises bridging a single steady-state connection for the media stream in the cellular core network and multiple steady-state connections for the RTP streams from the single SIP device.

6. The method of claim 1, the plurality of different RTP streams comprises a first RTP stream and a second RTP stream for the SIP device, further comprising:
identifying a second media stream from a second mobile device in the cellular core network; and
dynamically switching between connecting the first RTP stream with the first media stream for the first mobile device and the RTP stream with the second media stream for the second mobile device based, at least in part, on SIP signaling from the SIP device.

7. The method of claim 1, further comprising presenting the network node as a Base Station Controller (BSC) for the SIP device to a Mobile Switching Center (MSC) in the cellular core network.

8. The method of claim 1, further comprising determining status information for each RTP stream based, at least in part, on the SIP signals.

9. The method of claim 1, the network node comprising a subtending media gateway (MGW), further comprising controlling the MGW using H.248 in response to at least the RTP signaling.

10. A network node, comprising:
a first interface to an IP network;
a second interface to a cellular core network;
memory that stores criteria associated with RTP streams including SIP devices; and
one or more processors operable to:
identify, at a network node, a plurality of different RTP streams from a SIP device with at least one stream associated with a supplementary service, the SIP device in the IP network;
identify a first media stream from a first mobile device in the cellular core network; and
dynamically switch connections between the plurality of different RTP streams between corresponding single media streams for mobile devices in the cellular network based, at least in part, on SIP signaling from the SIP device, the single media streams include at least the first media stream of the first mobile device.

11. The network node of claim 10, further comprising controlling the dynamic switching using an access session border controller.

12. The network node of claim 10, further comprising translating between SIP communication and circuit switched communication.

13. The network node of claim 10, the network node receives the plurality of RTP streams through different interfaces to an IP network and receives the single media stream from the mobile device through a single interface to the cellular core network.

14. The network node of claim 10, wherein dynamically switching the single media stream between the plurality of different RTP streams comprises bridging a single steady-state connection for the media stream in the cellular core network and multiple steady-state connections for the RTP streams from the single SIP device.

15. The network node of claim 10, the plurality of different RTP streams comprises a first RTP stream and a second RTP stream for the SIP device, further comprising:
identifying a second media stream from a second mobile device in the cellular core network; and
dynamically switching between connecting the first RTP stream with the first media stream for the first mobile device and the RTP stream with the second media stream for the second mobile device based, at least in part, on SIP signaling from the SIP device.

16. The network node of claim 10, further comprising presenting the network node as a BSC for the SIP device to a MSC in the cellular core network.

17. The network node of claim 10, further comprising determining status information for each RTP stream based, at least in part, on the SIP signals.

18. The network node of claim 10, the network node comprising a MGW, further comprising controlling the MGW using H.248 in response to at least the RTP signaling.
